(19) United States
(12) Patent Application Publication
(10) Pub. No.: US 2013/0176093 A1
(43) Pub. Date: Jul. 11, 2013

(54) COIL FOR CURRENT LIMITATION

(71) Applicant: Raimund Summer, Kneiting (DE)

(72) Inventor: Raimund Summer, Kneiting (DE)

(73) Assignee: Schneider Electric Sachsenwerk GmbH, Regensburg (DE)

(21) Appl. No.: 13/547,355

(22) Filed: Jul. 12, 2012

(30) Foreign Application Priority Data
Jul. 14, 2011 (DE) 10 2011 107 252.0

(51) Int. Cl. H01F 27/28

(52) U.S. Cl. CPC H01F 27/28
USPC 336/73

(57) ABSTRACT

The invention relates to an electric coil for current limitation in medium voltage networks and high voltage networks, for example an inductance coil, having a conductive coil wire which is wound to form a cylindrical coil, with the conductive coil wire being wound around a segment of a core which conducts a closed magnetic flux. The core is interrupted by at least one non-magnetizable gap with small thickness to reduce a saturation of the core even with high currents flowing through the electric gap.

### CROSS-REFERENCE TO RELATED APPLICATIONS

This application claims the benefit of German Patent Application No. 10 2011 107 252.0, filed Jul. 14, 2011. The disclosure of the above application is incorporated herein by reference in its entirety.

### FIELD

The present invention relates to an electric coil for current limitation in medium voltage networks and high voltage networks having a conductive coil wire which is wound to form a cylindrical coil, with the conductive coil wire being wound around a segment of a core which conducts a closed magnetic flux. To avoid a saturation of the core at high currents which can flow through the electric coil, the core is interrupted by at least one non-magnetizable gap with a small thickness.

### BACKGROUND

Inductive current limiters which include an electric coil having a conductive coil wire which is wound around a segment of a core which conducts a closed magnetic flux are known in the art.

### SUMMARY

DE 32 02 600 A1 thus discloses such an inductive voltage and current limiter in which a portion of the core which is small with respect to the total volume of the core, which comprises ferromagnetic material of high permeability and low remanence, comprises a ferromagnetic material of high remanence and/or high coercivity. The portion with high remanence and/or high coercivity can be arranged in magnetic bypass to the core and have at least one air gap. On an excitation up to the saturation limit of the portion of high remanence and/or high coercivity, the magnetic resistance is very high and the inductance of the inductive voltage and current limiter only increases with increasing excitation to effect a current limitation on an exceeding of this saturation limit.

It is furthermore known for the avoidance of core saturation to provide the cores of such electric coils with an air gap which extends transversely to the magnetic flux and which can be filled with a non-magnetic material for mechanical stabilization. The air gap increases the magnetic resistance of the core, but results in scatter fields.

It is additionally known to manufacture the cores from a powder material which contains iron or iron alloys. The “powder cores”, in a similar manner to the air gap, bring about a more linear inductance development even at a high magnetization of the core, i.e. when a high magnetic field strength is applied to the core, and avoid the problem present with conventional cores that unavoidable gaps occur at connection parts of core portions from which the core is composed, with the hysteresis characteristic of the electric coil being varied by said gaps.

The use of air gaps results, as noted above, in scatter fields and accordingly in unwanted scatter field losses at the core interruptions formed by the air gaps, with the losses increasing disproportionately with the thickness of the air gap. A high magnetic resistance of the core, which likewise increases with the thickness of the air gap, is, however, required for avoiding the core saturation. An electric coil of the above-described type can thus be easily adapted to respectively required operating parameters by varying the air gap thickness.

With “powder cores”, in contrast, an optimization of the adjustability of the magnetization for the respectively required operating parameters is difficult and costly.

It is the object of the invention to avoid in a controlled manner the magnetic saturation of a magnetizable core material of an electric coil of the above-described type at current strengths in the windings of the conductive coil wire which lie in the range of some hundred to some thousand amperes and to optimize the electric coil for the respective application with respect to hysteresis losses, core material requirement and conductor material requirement.

This object is satisfied by the characterizing features of claim 1. Advantageous further developments are the subject of dependent claims.

Since a core of an electric coil which guides a closed magnetic flux is interrupted by a non-magnetizable gap of small thickness, it can largely be prevented that a high current which flows through a conductive coil wire which is wound around a segment of the core drives the core into saturation. The saturation of the core can be avoided in a controlled manner or the working range of the electric coil can be very largely displaced onto the non-saturated region of the magnetization curve of the core by the number, the arrangement and the thickness of the non-magnetizable gap and by the respective non-magnetizable material used in the non-magnetizable gaps. The electric coil can thus be optimized in a simple manner for the respective application.

Since the saturation is avoided, the electric coil can also provide a high inductance which can be used to limit the current even with large currents in the range of several thousand amperes.

In addition, scatter field losses are minimized by the small thickness of the gap. Since the total magnetic resistance of the core is increased by the gap or gaps, the magnetic flux through the core is reduced so that the core can be designed as smaller overall. The costs for the core material are thereby reduced and the construction size of the electric coil in accordance with the invention can be reduced. In addition, the required conductor material, i.e. the material of the conductive coil wire, can also be reduced by the reduction in size of the core since the diameter of the windings around the core segment is reduced and thus ohmic losses in the conductive coil wire are also reduced.

Due to the use of the gap, the non-linear B-H characteristic or hysteresis characteristic, which will be explained in more detail in FIGS. 3A and 3B, is sheared, that is the increase in the induction B is flattened and approximately linearized with respect to the magnetic field strength H. The effective region of the core is thereby restricted in the operating currents of the electric coil to the lower region of the B-H characteristic of the core material with a high differential permeability dB/dH and the magnetic hysteresis characteristic is effectively narrowed, whereby hysteresis losses are also reduced.

With inductive current limiters or restrictors, the effectiveness in the area of the design of the electric currents can thereby be maximized.

With transformers, the transmission ratio of the primary winding to the secondary winding can be maximized and linearized, whereby higher harmonic frequency portions are reduced in the secondary current or in the secondary voltage toward the operating frequency, as is shown in FIGS. 4A and 4B.

In a preferred practical embodiment, the thickness of the gap is designed so that it is small with respect to a diameter of the core. Scatter field losses caused by the gap can thereby be minimized.

A preferred embodiment arranges the gap in that segment of the core around which the conductive coil wire is wound. Since the inductive coupling is the largest in this segment, the gap has the greatest effect of the magnetic resistance generated by it at this point.

In a further embodiment, the gap is arranged outside the segment about which the conductive coil wire is wound. The arrangement facilitates the access to the gap in the course of maintenance and inspection work.

A further preferred embodiment uses a core which is made up of a plurality of parts, with the gap being arranged at a connection point between the parts of the core. The mechanical design of the electric coil in accordance with the invention is thereby simplified and measures can be omitted which are otherwise necessary for connecting the parts to avoid scatter losses and/or magnetic resistances which arise there.

A still further preferred embodiment uses a gap which only takes up an inner region of a cross-section of the core extending transversely to the magnetic flux so that the gap is completely embedded in the core. This embodiment improves the mechanical stability of the core, on the one hand, and results in a further reduction of the scatter field loss generated by the gap by a magnetic bypass path generated in this manner, on the other hand.

In accordance with a further preferred embodiment, the non-magnetic material contained in the gap includes air, a ceramic material, an epoxy resin or another paramagnetic material. The use of these materials allows an easy adaptation and optimization of the electric coil in accordance with the invention to the respective application.

The core preferably comprises a magnetically soft material, for instance iron or an iron alloy, to provide a path for the magnetic flux which has a low magnetic resistance and thus small magnetic losses.

In a further preferred embodiment, the electric coil is expanded by a second electric coil which is likewise wound around the core to form a fault current limiting device or a transformer in order thus to switch an inductance of the electric coil on excess current. In this respect, the second electric coil is preferably wound within the electric coil around that segment around which the electric coil is also wound to maximize the inductive coupling between the electric coils. The use of a gap of small thickness made from a non-magnetizable material maximizes and linearizes the transmission ratio onto the second coil and reduces higher harmonic frequency portions of current or voltage, which in turn reduces losses.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The electric coil in accordance with the invention will be described in the following with reference to an example using the enclosed Figures.

FIG. 1 shows a perspective sketch of an electric coil with an iron core which has a plurality of gaps of small thickness;

FIG. 2 shows a perspective sketch of a part of an iron core with a gap which is completely embedded in the iron core;

FIGS. 3A and 3B show a basic hysteresis curve of an electric coil with an iron core both without (3A) and with (3B) gaps in the iron core; and

FIGS. 4A and 4B show a basic temporal magnetic flux curve on excitation of an electric coil with an iron core by alternating current of the frequency 50 Hz without (4A) and with (4B) coils in the iron core.

### DETAILED DESCRIPTION

FIG. 1 shows an example embodiment of an electric coil 1 which includes an iron core 2 as well as a coil 4 which is formed from a conductive coil wire 3 and which is wound around a segment 5 of the iron core 2. When the electric coil 4 is excited by a current 1, as shown in FIG. 1, a magnetic flux Φ is formed in the iron core 2. The power the magnetic flux Φ has is determined by the magnetic flux density or induction B and by a cross-sectional area of the electric coil 4.

A plurality of gaps 6, 7 and 8 of small thickness which comprise a non-magnetizable material are introduced into the iron core 2 of the electric coil 1. The non-magnetizable gaps 6, 7 and 8 are all shown with the same thickness d, but can also have different thicknesses provided that they are all small with respect to a diameter of the iron core 2. In an example embodiment, the thickness of the gaps 6, 7 and 8 can lie in a range of less than 1 mm to approximately 10 mm with a diameter of the iron core 2 of 400 mm.

The arrangement of the gaps 6, 7 and 8 in the iron core 2 of FIG. 1 is only intended to illustrate basic possibilities for arranging the gaps in the iron core 2 and can differ from the example embodiment shown in FIG. 1 both in the number and in the arrangement in practical embodiments.

In preferred embodiments, columns 6 are used which are arranged in that segment of the iron core 2 around which the conductive coil wire 3 is wound since the inductive coupling between the coil wire 3 and the iron core 2 is the strongest in this region.

A further preferred position for gaps of non-magnetizable material is shown by the gaps 7 which are arranged at connection points of an iron core 2 which comprises a plurality of parts. These connection points are suitable for positioning the gaps 7 since otherwise a substantial construction effort is required there to design the connections so that no increased magnetic resistance and no scatter field losses arise there.

Any desired further positions for the gap/gaps are naturally possible. The gap 8 is an example for this and has—like the gaps 7—the advantage of easy accessibility for inspection and maintenance purposes.

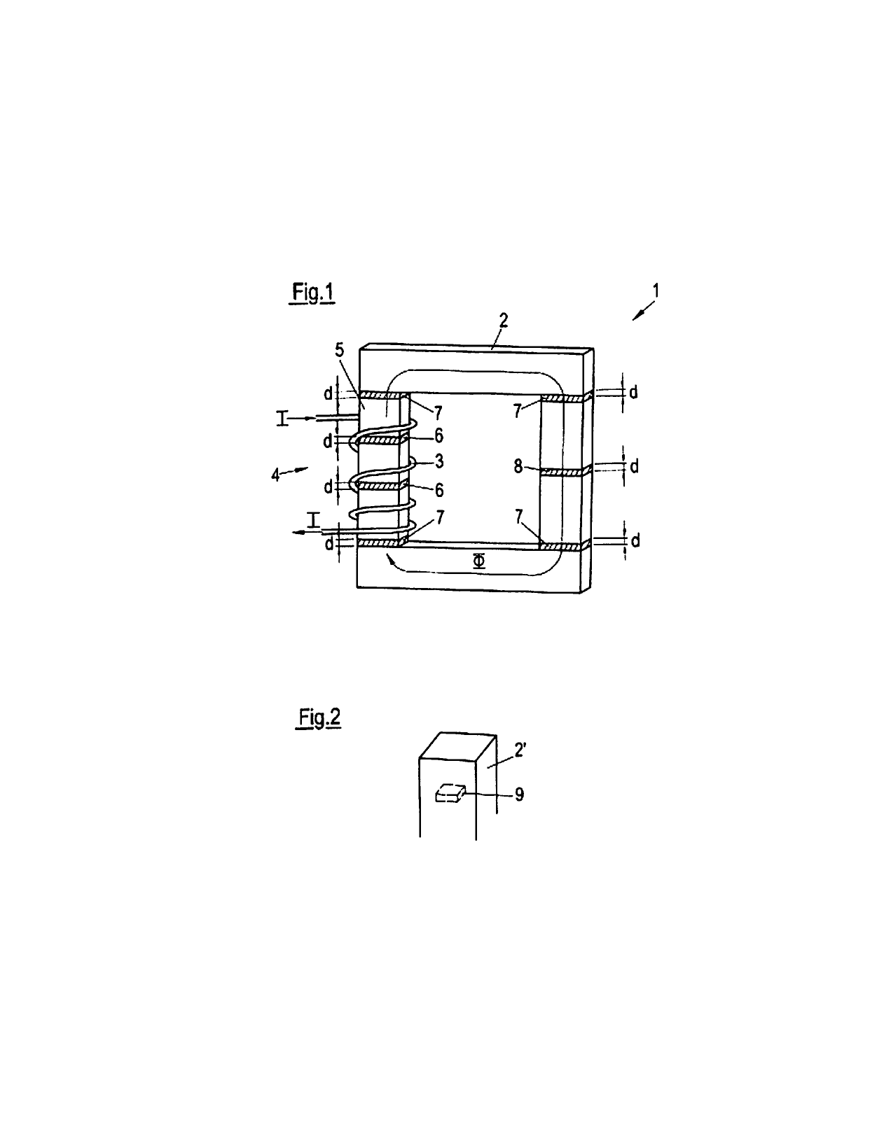

The gaps 6, 7 and 8 are shown in FIG. 1 so that they extend transversely to the direction of the magnetic flux Φ through the total diameter of the iron core 2 and thus completely interrupt it. FIG. 2 shows an alternative embodiment for the design of the gaps of small thickness with a non-magnetizable material. The gap 9 shown in FIG. 2 is arranged in an inner region of an iron core 2′. In this respect, the gap 9 only takes up the inner region of a cross-section of the iron core 2′ extending transversely to the magnetic flux so that it is completely embedded in the iron core 2′. Scatter field losses can be further reduced in comparison with the embodiment of gaps 6, 7 and 8 of FIG. 1 by the use of the embodiment of the gap 9 of FIG. 2. The embodiments of the gaps 6, 7 and 8, on the one hand, and of the gap 9, on the other hand, can also be used in any desired combination in an iron core.

The magnetic flux 0 is impeded by the introduction of the non-magnetizable gaps 6, 7 and 8 into the iron core 2 of FIG. 1 or of the gap 9 into the iron core 2′ of FIG. 2, i.e. the magnetic resistance opposed to the magnetic flux 0 by the core. On the overcoming of the regions with increased magnetic resistance, which are formed by the gaps 6, 7, 8 and 9, scatter flux fields are formed along the outer margins of the gaps which result in scatter field losses. These scatter field losses can be reduced by reducing the thickness of the gaps and by using the gap embodiment 9 of FIG. 2. With a small thickness of the gaps, the field lines of the scatter field at the margins of the gaps extend almost parallel to one another and to the magnetic flux 0 of the core and thereby reduce the losses caused by the scatter field.

The material with which the non-magnetizable gaps 6, 7, 8 and 9 can be filled, does not have to be magnetizable, for instance air, a ceramic material, an epoxy resin or generally a material having paramagnetic properties. In principle, aluminum would also be possible, but its proneness to the generation of eddy currents which result in eddy current losses has a negative effect in practice.

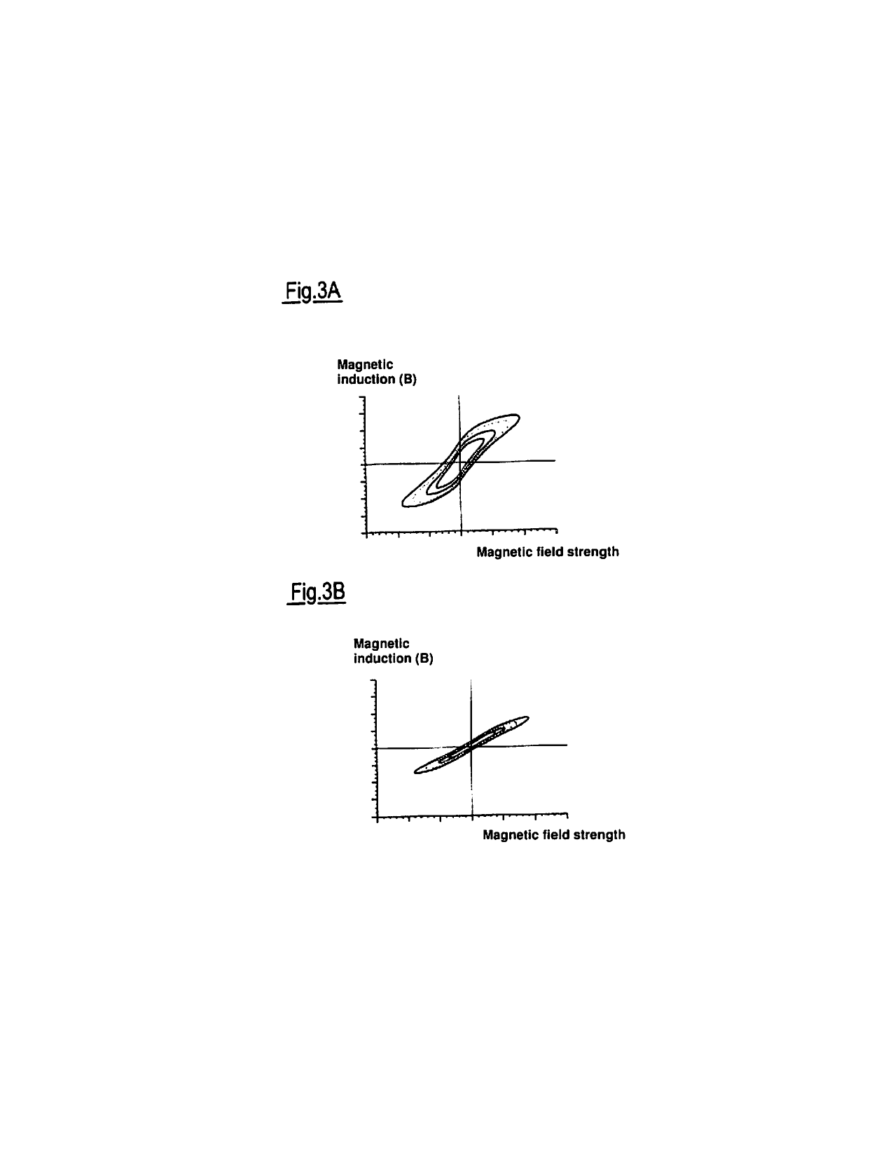

FIGS. 3A and 3B show the basic extent of the hysteresis characteristic or hysteresis curve of an iron core with a gap (FIG. 3A) and of an iron core with a gap (FIG. 3B), for instance of the exemplary iron core 2 of FIG. 1, with different orders of magnitude of the applied current I. It can be recognized that the hysteresis curve of FIG. 3B is sheared in comparison with FIG. 3A, i.e. is flattened and linearized, so that a larger magnetic field strength H is required for reaching the same value of the magnetic induction B. A larger magnetic field strength H or a larger current I is thus also required in the electric coil 4 of FIG. 1 to reach the saturation of the core.

The linearization of the hysteresis curve of the core results in an effective narrowing of the hysteresis curve and thus in a reduction of hysteresis losses which arise, for example, on the running through of the hysteresis curve when an alternating current is applied to the electric coil 4 of FIG. 1.

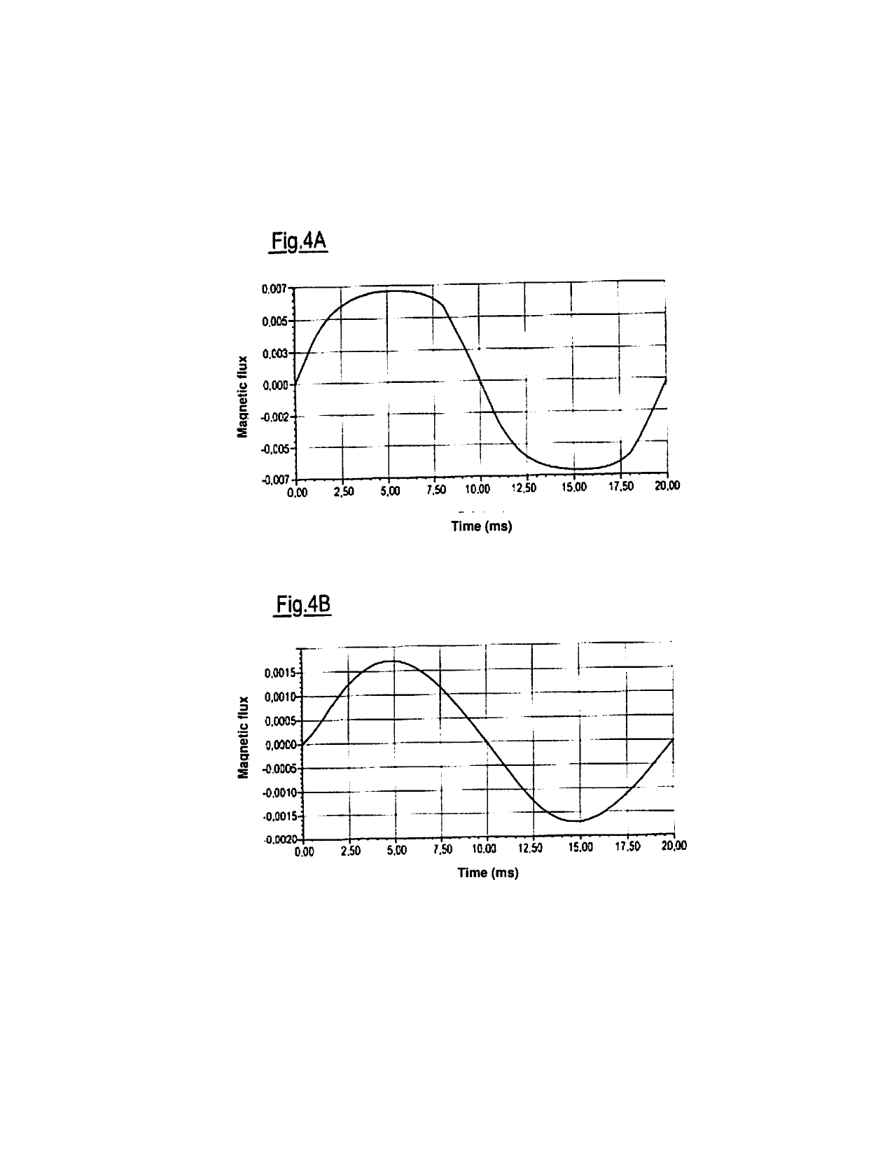

FIGS. 4A and 4B show a further advantageous effect provided by the use of the non-magnetizable gap in the iron core 2. The two curves shown in FIGS. 4A and 4B are the result of a simulation program in which an iron core (material steel 1008) is wound around by an electric coil, with the core in FIG. 4A having no gaps, whereas the core in FIG. 4B was provided with four air gaps 6 of a thickness 2 mm. The electric coil is excited by alternating current with a frequency of 50 Hz.

FIG. 4A shows a considerably higher amplitude of the magnetic flux than FIG. 4B due to the lower magnetic resistance. Whereas FIG. 4B shows an almost ideal sinusoidal extent, i.e. only minimal distortions or harmonics, the curve of FIG. 4A has clearly recognizable deviations from an ideal sinus curve. These deviations are caused by the saturation of the core and result in harmonics and distortions which have a negative effect on the signal quality and moreover result in unwanted losses.

In summary, the use of one or more gaps of small thickness with non-magnetizable material in a magnetizable core of an electric coil such that a magnetic saturation of the current is avoided and hysteresis losses are reduced by a shearing of the B-H characteristic of the core thereby caused. The use of a plurality of gaps of small thickness with a non-magnetizable material moreover enables, by the small thickness of the individual gaps, the reduction of scatter field losses which arise at these gaps and thereby enables the realization of a total resistance of the core larger overall. The core can thereby be reduced in size overall, which results in a construction size of the electric coil or of the fault current apparatus smaller and more compact overall and in a reduction of the quantity of the required coil wire and of the associated ohmic resistance.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

What is claimed is:

1. An electric coil for current limitation in medium voltage networks and high voltage networks having a conductive coil wire which is wound to form a cylindrical coil, wherein the conductive coil wire is wound around a segment of a core which guides a closed magnetic flux, with the core being interrupted by at least one non-magnetizable gap with a small thickness to reduce a saturation of the core even with high currents flowing through the electric coil.

2. An electric coil in accordance with claim 1, wherein the electric coil is an inductance coil.

3. An electric coil in accordance with claim 1, wherein the thickness of the gap is small with respect to a diameter of the core.

4. An electric coil in accordance with claim 1, wherein the gap is arranged in that segment of the core around which the conductive coil wire is wound.

5. An electric coil in accordance with claim 1, wherein the gap is arranged outside the segment of the core around which the conductive coil wire is wound.

6. An electric coil in accordance with claim 1, wherein the core is made up of a plurality of parts and the gap is arranged at a connection point between the parts of the core.

7. An electric coil in accordance with claim 1, wherein the gap only takes up an inner region of a cross-section of the core extending transversely to the magnetic flux so that the gap is completely embedded in the core.

8. An electric coil in accordance with claim 1, wherein the material contained in the gap includes air, a ceramic material, an epoxy resin or another paramagnetic material.

9. An electric coil in accordance with claim 1, wherein the core is made up of a magnetic soft material.

10. A fault current limiting apparatus for medium voltage networks and high voltage networks having a first electric coil for current limitation in said medium voltage networks and said high voltage networks, said first electric coil having a conductive coil wire which is wound to form a cylindrical coil, wherein the conductive coil wire is wound around a segment of a core which guides a closed magnetic flux, with the core being interrupted by at least one non-magnetizable gap with a small thickness to reduce a saturation of the core even with high currents flowing through the electric coil, wherein the fault current limiting apparatus includes a second electric coil which is wound around the core to switch an inductance of the first electric coil.

11. A fault current limiting apparatus for medium voltage networks and high voltage networks having a first electric coil in accordance with claim 10, wherein the second electric coil is wound around the segment of the core within the first electric coil.
